(19) United States
(12) Patent Application Publication
(10) Pub. No.: US 2011/0032867 A1
(43) Pub. Date: Feb. 10, 2011

(54) SYSTEM FOR GENERATING BEAMS WITH GROUND-OPERATED PROCESSING AND DIGITAL TRANSMISSION

(75) Inventors: Jean-Didier Gayrard, Toulouse (FR); Cecile Guiraud, Goyrans (FR); Isabelle Buret, Plaisance Du Touch (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, NEUILLY/SUR/SEINE (FR)

(21) Appl. No.: 12/920,938

(22) PCT Filed: Feb. 19, 2009
(86) PCT No.: PCT/EP2009/052001

§ 371 Date: Oct. 12, 2010

(30) Foreign Application Priority Data
Mar. 4, 2008 (FR) 0801185

(51) Int. Cl. H04B 7/185

(52) U.S. Cl. 370/316

(57) ABSTRACT

A ground-based beam-forming system includes a satellite and a ground-based processing base equipped with beam-forming means. The satellite is equipped with first transmission/reception means for sending and receiving analog signals with remote terminals, and second transmission/reception means for sending and receiving signals with ground-based third transmission/reception means communicating with the processing base. The satellite includes digitizing means suitable for converting analog signals received by the first transmission/reception means into digital signals, the digitizing means being directly connected to the first transmission/reception means.

The invention relates to a ground-based beam-forming system (GBBF).

The expression “beam-forming” relates to the function fulfilled by a system in which the energy radiated by an antenna with radiant elements is focused in a specific direction. The objective is also to receive preferentially signals from a particular direction or send preferentially signals in a particular direction. Such systems are generally used for remote terminals such as cell phones or digital decoders. The beam-forming can be performed in the satellite or in a base station located on the ground.

Since the present invention relates to a ground-based beam-forming system, the beam-forming is performed by the base station. Performing the beam-forming on the ground offers various advantages. Firstly, the load onboard the satellite is reduced, because the beamformers are arranged in the ground-based base station and not in the satellite. The cost is also reduced, because the beamformers used are not subject to the technical constraints, for example size or weight, that are fundamental to having them onboard a satellite. Finally, the ground-based beam-forming allows for a flexibility of use and an open-endedness of the system that are clearly better than beam-forming performed in the satellite. In practice, throughout the satellite's operating life, typically of the order of ten years, the number of beamformers may easily be increased if the demand increases, and beamformers or connected processing devices may easily be changed or updated in line with technical advances.

However, in the ground-based beam-forming systems, it is difficult to obtain on the ground a faithful copy of the signals received by the satellite from remote terminals, and transmitted by the satellite to the ground-based base station. Similarly, it is equally, it is difficult to obtain in the satellite a faithful copy of the signals transmitted by the base station.

One aim of the invention is to mitigate these drawbacks.

According to one aspect of the invention, there is proposed a ground-based beam-forming system comprising a satellite and a ground-based processing base equipped with beam-forming means, said satellite being equipped with first emission/reception means for sending and receiving analog signals with remote terminals, and second emission/reception means for sending and receiving signals with ground-based third emission/reception means communicating with said processing base.

The satellite comprises:

digitizing means suitable for converting analog signals received by the first emission/reception means into digital signals, said digitizing means being directly connected to the first emission/reception means, and

digital processing means directly connected to the digitizing means, and the processing base comprises beam-forming means and processing means connected to said third emission/reception means.

By digitizing the signals as close as possible to the reception source of the analog signals transmitted by remote terminals, it is possible to avoid a degradation of the signals between their reception and their digitization in the satellite.

In one embodiment, said second and third emission/reception means are suitable for communicating by digital signals.

Such a system makes it possible to substantially limit the differences between the signals received by the satellite from remote terminals, and the signals received by the ground-based base station after transmission by the satellite. In practice, transmitting signals in digital form makes it possible to significantly reduce the transmission error rate compared to analog transmissions.

Furthermore, when transmitting signals in digital form, the addition of noise is substantially limited by comparison to an analog signal transmission.

In one embodiment, the digital processing means of the satellite comprise digital filtering means suitable for filtering digital signals.

Such filtering enhances the quality of the signals.

In one embodiment, the digital processing means of the satellite comprise compression means for compressing digital signals.

This data compression limits the bandwidth needed for the transmission of the signals.

In one embodiment, the digital processing means of the satellite comprise means of adding time-division multiplexing information to the digitized signals, and digital signal time-division multiplexing means.

Thus, a time-division multiplexing of the signals can be performed by adding information so that a corresponding demultiplexing can be carried out when said signals are received on the ground.

In one embodiment, the processing means of the ground-based processing base comprise digital signal demultiplexing means.

In one embodiment, said processing means of the ground-based processing base comprise digital signal decompression means.

In one embodiment, said second emission/reception means comprise, in addition, a modulator for modulating the digital signals.

In one embodiment, the system comprises a ground-based demodulator for demodulating the digital signals received from the satellite.

The original signal is thus recovered.

According to another aspect of the invention, there is also proposed a ground-based beam-forming system comprising a satellite and a ground-based processing base equipped with beam-forming means, said satellite being equipped with first emission/reception means for sending and receiving analog signals with remote terminals, and second emission/reception means for sending and receiving signals with ground-based third emission/reception means communicating with said processing base.

The satellite comprises:

conversion means suitable for converting digital signals received by the second emission/reception means into analog signals, said conversion means being directly connected to the first emission/reception means, and

digital processing means directly connected to the conversion means, and in that the processing base comprises beam-forming means and processing means connected to said ground-based third emission/reception means.

Thus, the digital signals received from the ground-based base station by the satellite are converted into analog signals as close as possible to the source of emission of the analog signals from the satellite, which avoids a degradation of the signals between their analog conversion and their emission to the remote terminals.

In one embodiment, said second and third emission/reception means are suitable for communicating by digital signals.

Such a system makes it possible to substantially limit the differences between the signals sent by the ground-based base station received by the satellite and the signals transmitted by the satellite to the remote terminals. In practice, transmitting signals in digital form makes it possible to significantly reduce the transmission error rate compared to current analog transmissions.

Furthermore, in a transmission of signals in digital form, the addition of noise is substantially limited in comparison to an analog signal transmission.

In one embodiment, the processing means of the ground-based processing base comprise digital filtering means suitable for filtering digital signals.

The quality of the signals is thus enhanced.

In one embodiment, the processing means of the ground-based processing base comprise compression means for compressing digital signals.

This data compression limits the band width needed for the signal transmission.

In one embodiment, the processing means of the ground-based processing base comprise means of adding time-division multiplexing information to the digitized signals, and digital signal time-division multiplexing means.

It is thus possible to perform a time-division multiplexing of the signals by adding information so that a corresponding demultiplexing can be carried out when said signals are received by the satellite.

In one embodiment, the digital processing means of the satellite comprise digital signal demultiplexing means.

In one embodiment, the digital processing means of the satellite comprise digital signal decompression means.

In one embodiment, the ground-based third emission/reception means comprise a modulator for modulating the digital signals.

In one embodiment, said second emission/reception means comprise a demodulator for demodulating the digital signals received from the ground-based processing base.

The initial signal is thus retrieved.

In one embodiment, said remote terminals comprise cell phones or digital television terminals.

According to another aspect of the invention, there is also proposed a ground-based beam-forming method wherein analog signals received by a satellite after transmission by remote terminals are converted into digital signals, said conversion taking place before any subsequent processing of the received signals.

According to another aspect of the invention, there is also proposed a ground-based beam-forming method wherein digital signals received by a satellite after emission by a ground-based processing base are converted into analog signals, said conversion taking place directly before the emission of the signals to remote terminals.

The invention will be better understood upon studying a few embodiments described as nonlimiting examples and illustrated by the appended drawings in which:

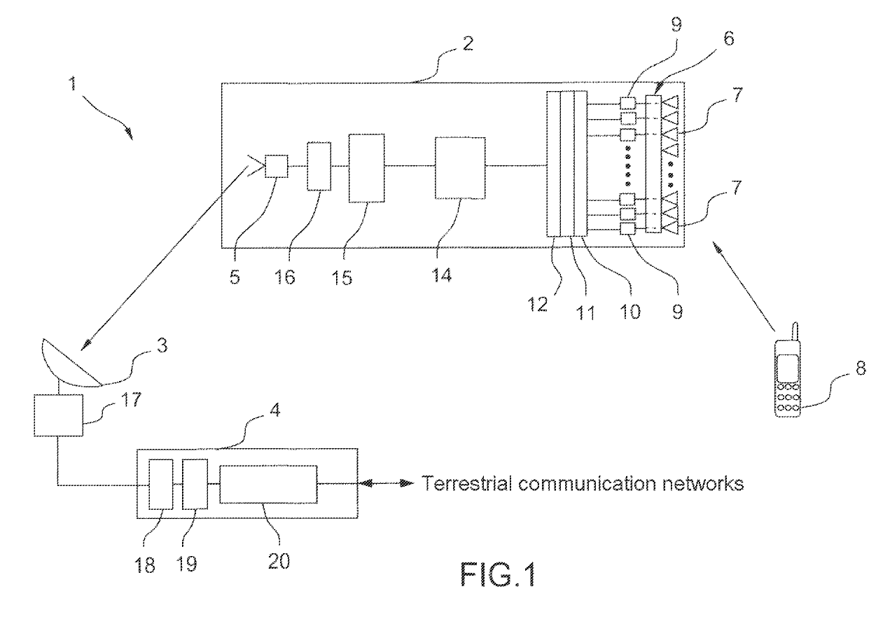

FIG. 1 diagrammatically illustrates a ground-based beam-forming system, according to a first aspect of the invention (receiving signals from remote terminals via a satellite with transmission of these signals to the ground-based processing base); and

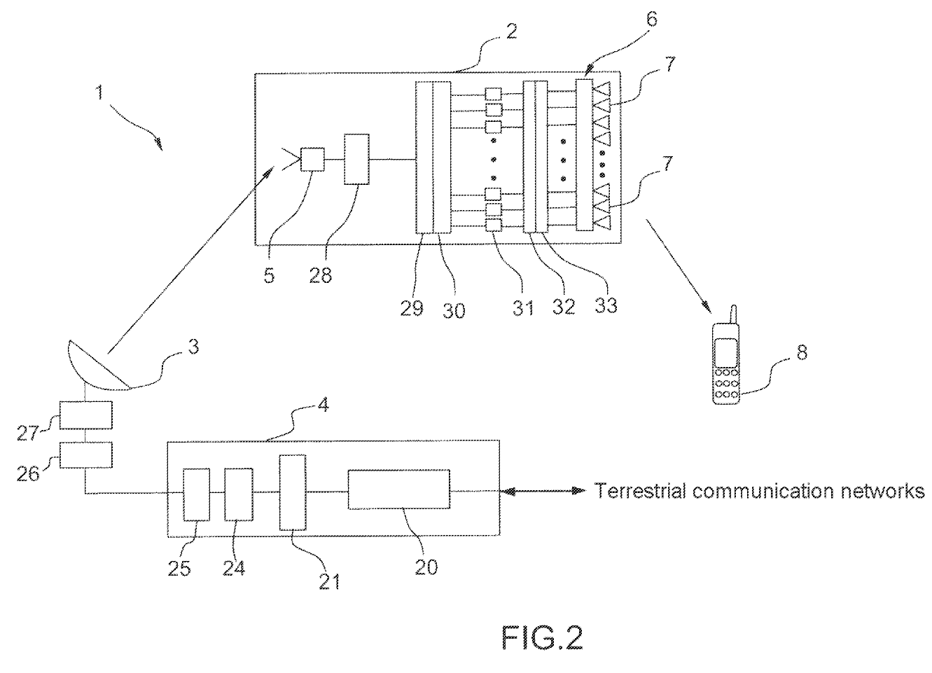

FIG. 2 diagrammatically illustrates a ground-based beam-forming system, according to a second aspect of the invention (with reception by a satellite of signals from the ground-based processing base with emission of these signals to the remote terminals).

As illustrated in FIG. 1, a ground-based beam-forming system 1 comprises a satellite 2, a ground-based emission/reception antenna 3, and a ground-based processing base 4. Obviously, the ground-based receptions/emissions may, as a variant, be performed by a plurality of emission/reception antennas, all communicating with the base 4. Hereinafter in the description, we will assume, in a nonlimiting manner, that the communications between the satellite 2 and the base station 4 are conducted by a single emission/reception element 5 of the satellite 2 and a single ground-based emission/reception antenna 3.

The satellite 2 comprises an antenna 6 with radiant elements 7 each transmitting the analog signals that they receive from remote terminals, such as cell phones 8. As a variant, the invention applies to other types of remote terminals, for example digital television terminals. The antenna 6 may be provided with anti-rectification filters associated with the radiant elements 7. Digitizing modules 9 are directly connected to the antenna 6 for converting the respective analog signals received by the radiant elements 7 into digital signals, in order to transmit them to a module 10 for adding information (framer) enabling a time-division multiplexer 11 to multiplex all the signals received from the digitizing modules 9.

These signals can then be filtered by optional digital filters 12 and compressed by an optional compression module 13, in order to respectively enhance the quality of the signals obtained and limit the necessary band width. The satellite 2 also comprises a modulator 14 for modulating the digital signals in order to transmit them on a carrier. The satellite 2 also comprises a frequency changing module 15 and an amplifier 16 for amplifying the digital signals to be transmitted by the emission/reception element 5.

The antenna 3 receives the digital signals transmitted by the satellite 2 and transmits them to a demodulator 17 for them to be demodulated. The demodulated signals are transmitted to the base 4 which comprises an optional decompression module 18 if the signal has been compressed in the satellite 2, and a demultiplexer 19 which delivers as output digital signals corresponding to the signals digitized in the satellite 2 upon reception, to a processing module 20 that can implement the beam-forming and possibly additional processing operations.

FIG. 1 illustrates the reception of signals from remote terminals 8 by the satellite 2 with transmission of the signals to the ground-based processing base 4.

FIG. 2 illustrates an equivalent system to that of FIG. 1, with reception by the satellite 2 of signals from the ground-based processing base 4 with emission of the signals to the remote terminals 8. The elements that are the same as those in FIG. 1 have the same numerical references.

As illustrated in FIG. 2, a ground-based beam-forming system 1 comprises a satellite 2, a ground-based emission/reception antenna 3, and a ground-based processing base 4. The communications between the satellite 2 and the base station 4 are, for example, conducted by a single emission/reception element 5 of the satellite 2 and a single ground-based emission/reception antenna 3.

The beam-forming processing module 20 of the base 4 delivers digital signals to a module 21 for adding information (framer) enabling a time-division multiplexer 22 to multiplex these signals. These signals can then be filtered by optional digital filters 23 and compressed by an optional compression module 24, in order respectively to enhance the quality of the signals obtained and limit the necessary band width. The ground-based processing also comprises, at the output of the base station 4, a modulator 25 for modulating the digital signals in order to transmit them on a carrier, a frequency changing module 26 and an amplifier 27 for amplifying the digital signals to be transmitted by the ground-based emission/reception antenna 3 to the satellite 2.

The emission/reception element 5 of the satellite 2 receives these signals and transmits them to a demodulator 28 which demodulates them. The demodulated signals can then, optionally, be decompressed by an optional decompression module 29, and demultiplexed by a demultiplexer 30, which delivers as output a set of demultiplexed signals. The demultiplexed signals are then converted into analog signals by convertors 31, then modified in frequency by a frequency changing module 32 and amplified by an amplifier 33 in order to be transmitted, in analog form, by the antenna 6 with radiant elements 7 to the remote terminals 8. The elements 6, 7, 32, 33 form an active antenna in emission and/or reception.

FIG. 2 illustrates the reception of signals from the processing base 4 by the satellite 2 with transmission of these signals to the remote terminals 8.

Obviously, in another embodiment, a ground-based beam-forming system may contain both the elements of the embodiment of FIG. 1 and the elements of the embodiment of FIG. 2.

The present invention allows for ground-based beam-forming allowing the degradation of signals transmitted to the ground to be limited. Furthermore, with the use of a digital format, the trend in digital processing will make it possible to reduce consumption and minimize footprint.

1. A ground-based beam-forming system comprising:
a satellite; and
a ground-based processing base equipped with beam-forming means, said satellite being equipped with first emission/reception means for sending and receiving analog signals with remote terminals and second transmission/reception means for sending and receiving signals with ground-based third emission/reception means communicating with said processing base, wherein the satellite comprises:
digitizing means suitable for converting analog signals received by the first emission/reception means into digital signals, said digitizing means being directly connected to the first emission/reception means; and
digital processing means directly connected to the digitizing means, wherein the processing base comprises beam-forming means and processing means connected to said third emission/reception means.

2. The system as claimed in claim 1, wherein said second and third emission/reception means are suitable for communicating by digital signals.

3. The system as claimed in claim 1, wherein said digital processing means of the satellite comprises digital filtering means suitable for filtering digital signals.

4. The system as claimed in claim 1, wherein said digital processing means of the satellite comprises compression means for compressing digital signals.

5. The system as claimed in claim 1, wherein said digital processing means of the satellite comprises means of adding time-division multiplexing information to the digitized signals, and digital signal time-division multiplexing means.

6. The system as claimed in claim 5, wherein said processing means of the ground-based processing base comprises digital signal demultiplexing means.

7. The system as claimed in claim 4, wherein said processing means of the ground-based processing base comprises digital signal decompression means.

8. The system as claimed in claim 1, wherein said second emission/reception means comprise, in addition, a modulator for modulating the digital signals.

9. The system as claimed in claim 8, further comprising a ground-based demodulator for demodulating the digital signals received from the satellite.

10. A ground-based beam-forming system comprising a satellite and a ground-based processing base equipped with beam-forming means , said satellite being equipped with first emission/reception means for sending and receiving analog signals with remote terminals, and second transmission/reception means for sending and receiving signals with ground-based third emission/reception means communicating with said processing base, wherein the satellite comprises:
conversion means suitable for converting digital signals received by the second emission/reception means into analog signals, said conversion means being directly connected to the first emission/reception means ; and
digital processing means directly connected to the conversion means,
wherein the processing base comprises beam-forming means and processing means connected to said ground-based third emission/reception means.

11. The system as claimed in claim 10, wherein said second and third emission/reception means are suitable for communicating by digital signals.

12. The system as claimed in claim 10, wherein said processing means of the ground-based processing base comprises digital filtering means suitable for filtering digital signals.

13. The system as claimed in claim 10, wherein said processing means of the ground-based processing base comprises compression means for compressing digital signals.

14. The system as claimed in claim 10, wherein said processing means of the ground-based processing base comprises means of adding time-division multiplexing information to the digitized signals, and digital signal time-division multiplexing means.

15. The system as claimed in claim 14, wherein said digital processing means of the satellite comprises digital signal demultiplexing means.

16. The system as claimed in claim 13, wherein said digital processing means of the satellite comprises digital signal decompression means.

17. The system as claimed in claim 10, wherein said ground-based third emission/reception means comprise a modulator for modulating the digital signals.

18. The system as claimed in claim 18, wherein said second emission/reception means comprise a demodulator for demodulating the digital signals received from the ground-based processing base.

19. The system as claimed in claim 10, wherein said remote terminals comprise cell phones or digital television terminals.

20. A ground-based beam-forming method utilizing the system of claim 1, wherein analog signals received by the satellite after emission by the remote terminals are converted into digital signals, said conversion taking place before any subsequent processing of the received signals.

21. A ground-based beam-forming method utilizing the system of claim 1, wherein digital signals received by the satellite after emission by the ground-based processing base are converted into analog signals, said conversion taking place directly before the emission of the signals to remote terminals.
